(19) United States
(12) Patent Application Publication
(10) Pub. No.: US 2026/0095983 A1
(43) Pub. Date: Apr. 2, 2026

(54) COOKING APPARATUS

(71) Applicant: SAMSUNG ELECTRONICS CO., LTD., Suwon-si (KR)

(72) Inventors: Jaehee JO, Suwon-si (KR); Changhyun SON, Suwon-si (KR); Sungmin OH, Suwon-si (KR); Seokho YOO, Suwon-si (KR); Minho YUN, Suwon-si (KR); Sunwoo HAN, Suwon-si (KR)

(73) Assignee: SAMSUNG ELECTRONICS CO., LTD., Suwon-si (KR)

(21) Appl. No.: 19/337,277

(22) Filed: Sep. 23, 2025

Related U.S. Application Data
(63) Continuation of application No. PCT/KR2025/095534, filed on Sep. 4, 2025.

(30) Foreign Application Priority Data
Sep. 30, 2024 (KR) 10-2024-0133392

(51) Int. Cl. H05B 6/12

(52) U.S. Cl. CPC H05B 6/1263

(57) ABSTRACT

A cooking apparatus may include a main body forming a cooking room, a cooktop including a machine room accommodating an induction heating coil and a fan positioned inside the machine room, the cooktop positioned above the main body, a duct extending from a lower portion of the main body toward the fan and configured to guide air below the main body to the fan, and an air guide configured to guide air discharged to one side of the machine room by the fan downward from the machine room. The air guide may be configured to guide air guided from one side of the machine room downward from the machine room toward another side of the machine room.

### CROSS REFERENCE TO RELATED APPLICATION

This application is a continuation application, under 35 USC § 111 (a), of International Application No. PCT/KR2025/095534 filed on Sep. 4, 2025 which claims priority to Korean Patent Application No. 10-2024-0133392 filed on Sep. 30, 2024, in the Korean Intellectual Property Office, the disclosure of which is incorporated by reference herein in its entirety.

### TECHNICAL FIELD

The present disclosure relates to a cooking apparatus.

### BACKGROUND ART

A cooking apparatus is an appliance for cooking a cooking material such as food by heating the cooking material. The cooking apparatus performs various functions related to cooking, such as heating, defrosting, drying, sterilizing, etc. of a cooking material.

Examples of such a cooking apparatus include ovens such as gas ovens or electric ovens, microwave ovens (hereinafter referred to as microwave), gas ranges, electric ranges, gas grills or electric grills, radiant cooktops, induction cooktops, etc.

To improve space utilization and user convenience, the cooking apparatus includes an oven and a cooktop provided above the oven. The cooktop includes at least one of a gas range cooktop, an electric range cooktop, a radiant cooktop, or an induction cooktop.

In a cooking apparatus including an oven and an induction cooktop, electrical components inside the induction cooktop placed above the oven may be damaged due to heat from the oven.

### DISCLOSURE

### Technical Problem

An aspect of the disclosure provides a cooking apparatus for discharging stagnant heat between an oven and an induction cooktop to outside of the cooking apparatus by using a fan provided inside the induction cooktop.

An aspect of the disclosure provides a cooking apparatus including an oven and an induction cooktop provided above the oven and capable of discharging stagnant heat above the oven to outside without adding a separate fan.

An aspect of the present disclosure provides a cooking apparatus for discharging heat above an oven to outside by guiding air that has cooled inside of an induction cooktop over the oven.

The technical object intended to be achieved by the present document is not limited to the above-mentioned technical objects, and other technical objects not mentioned will be clearly understood by one of ordinary skill in the technical art to which the disclosure belongs from the following description.

### Technical Solution

According to an embodiment of the disclosure, a cooking apparatus may include: a main body forming a cooking room; a cooktop including a machine room to accommodate an induction heating coil and a fan, the cooktop being positioned above the main body; a duct extending from a lower portion of the main body toward the fan and configured to guide air from below the main body to the fan; and an air guide configured to: guide air to a first side of the machine room by the fan, the air being guided along a downward direction from the machine room, and wherein the air guide is configured to guide air guided from the first side of the machine room toward a second side of the machine room.

### DESCRIPTION OF DRAWINGS

FIG. 1 is a perspective view of a cooking apparatus according to an embodiment.

FIG. 2 shows a cooking apparatus according to an embodiment after a top plate of a cooktop is separated from the cooking apparatus.

FIG. 3 is an exploded view showing some components of a cooking apparatus according to an embodiment.

FIG. 4 is a bottom perspective view of a cooktop and a protruding portion in a cooking apparatus according to an embodiment.

FIG. 5 is a side cross-sectional view of a cooking apparatus according to an embodiment.

FIG. 6 is an enlarged view of an area A of FIG. 5.

FIG. 7 shows some components of a cooking apparatus according to an embodiment.

FIG. 8 shows some components of the cooking apparatus shown in FIG. 7 and an air guide separated from the components.

FIG. 9 shows some components of a cooking apparatus according to an embodiment.

FIG. 10 shows some components of the cooking apparatus shown in FIG. 9 and an air guide separated from the components.

FIG. 11 is an enlarged view showing a part of a side cross section of a cooking apparatus according to an embodiment.

### MODES OF THE INVENTION

The embodiments described in the disclosure and the configurations shown in the drawings are only examples of the disclosure, and various modifications may be made at the time of filing of the disclosure to replace the embodiments and drawings of the disclosure.

In the description of the drawings, like numbers refer to like elements throughout the description of the drawings.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

The terms of “˜part”, “˜module” and “˜member” may be implemented in hardware or software. In some embodiments, a plurality of “˜parts”, “˜modules” and “˜members” may be implemented as a single component. In some embodiments, a single “˜part”, “˜module” and “˜member” may include a plurality of components.

The terms used herein are for the purpose of describing the embodiments and are not intended to restrict and/or to limit the disclosure. The singular expressions herein may include plural expressions, unless the context clearly dictates otherwise. In addition, the terms “comprises”, “includes”, and “has” are intended to indicate that there are features, numbers, steps, operations, elements, parts, or combinations thereof described in the specification, and do not exclude the presence or addition of one or more other features, numbers, steps, operations, elements, parts, or combinations thereof.

It will be understood that, although the terms first, second, etc. used in the disclosure may be used herein to describe various components, these components should not be limited by these terms. These terms are only used to distinguish one component from another. For example, a first element could be termed a second element, and similarly, a second element could be termed a first element without departing from the scope of the disclosure. The term “and/or” includes combinations of one or all of a plurality of associated listed items.

When one (e.g., a first) element is referred to as being “coupled” or “connected” to another (e.g., a second element with or without the term “functionally” or “communicatively,” it means that the one element is connected to the other element directly, wirelessly, or via a third element.

It will be understood that when a certain component is referred to as being “connected to”, “coupled to”, “supported by” or “in contact with” another component, it may be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” another component, it may be directly on the other component or intervening components may also be present.

Meanwhile, the terms such as “up-down direction,” “front-rear direction,” and the like used in the following description are defined based on the accompanying drawings, and the shapes and positions of the respective components are not limited by these terms.

Hereinafter, an embodiment of the disclosure will be described in detail with reference to the accompanying drawings.

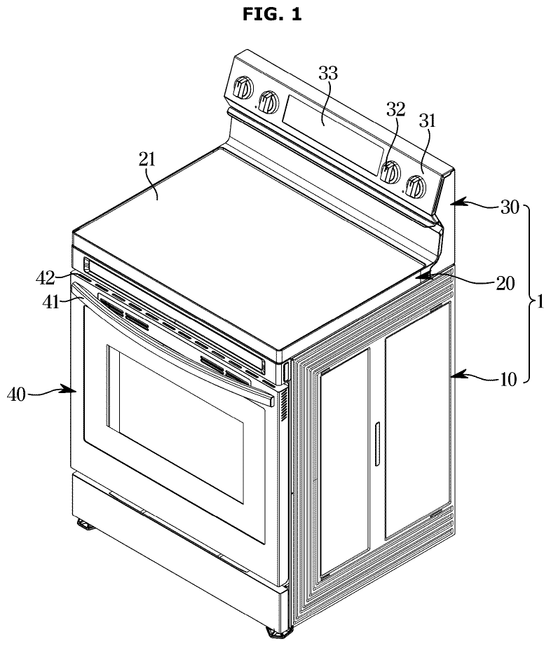

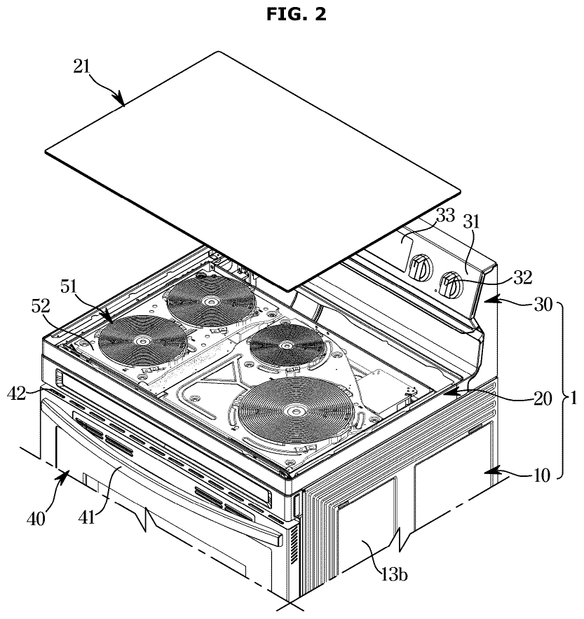

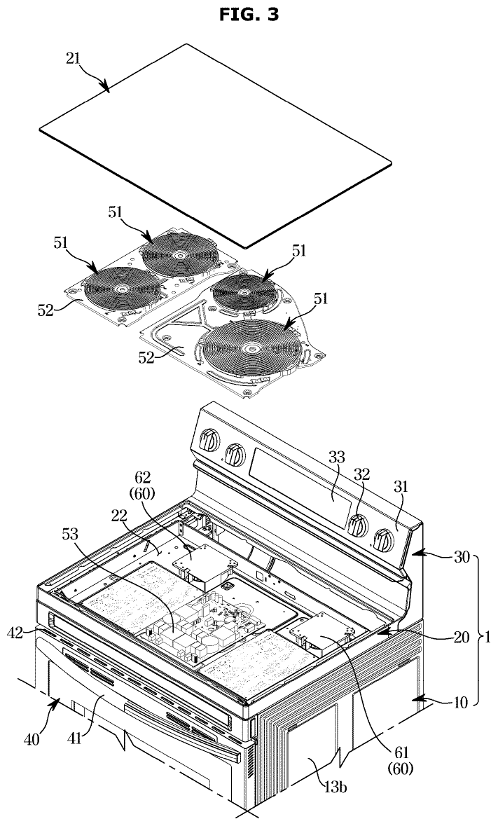

FIG. 1 is a perspective view of a cooking apparatus according to an embodiment. FIG. 2 shows a cooking apparatus according to an embodiment after a top plate of a cooktop is separated from the cooking apparatus. FIG. 3 is an exploded view showing some components of a cooking apparatus according to an embodiment.

Referring to FIGS. 1 to 3, a cooking apparatus 1 may include a main body 10, and a cooktop 20 provided above the main body 10. The main body 10 may be referred to as an oven. The cooktop 20 may be referred to as an induction heating device.

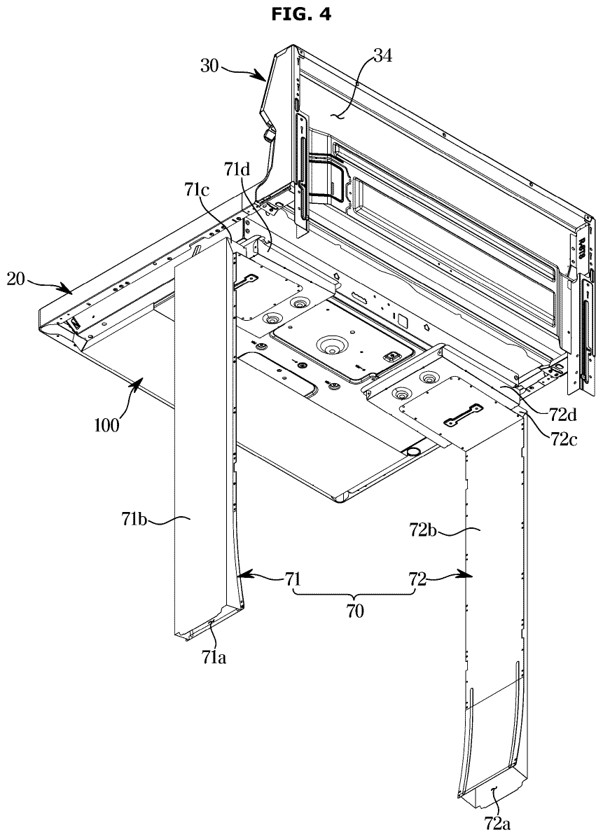

The main body 10 may form a cooking room 11 (see FIG. 4) therein. The main body 10 may be configured to heat inside of the cooking room 11. The main body 10 may include a heater for heating the inside of the cooking room 11. The heater may be an electric heater including an electric resistor. Alternatively, the heater may be a gas heater that generates heat by burning gas. The main body 10 may be a gas oven or an electric oven.

The main body 10 may include an inner case 12 (see FIG. 4) forming a cooking room 11, and an outer case 13 coupled to an outer side of the inner case 12 and forming an appearance of the cooking apparatus 1. Each of the inner case 12 and the outer case 13 may have substantially a box shape of which a front side opens.

The main body 10 may include an insulation provided between the inner case 12 and the outer case 13 to insulate between the inner case 12 and the outer case 13.

The outer case 13 may include a front panel forming a front surface of the main body 10, side panels 13b forming sides of the main body 10, and a rear panel 13c forming a rear surface of the main body 10.

The main body 10 may include a door 40 that opens or closes the cooking room 11. The door 40 may be rotatably coupled to the main body 10. The door 40 may open or close the cooking room 11 by rotating with respect to the main body 10. For example, the door 40 may be coupled to a lower end of the main body 10. The door 40 may rotate on a rotation shaft positioned at or adjacent to the lower end of the main body 10.

The door 40 may include a door handle 41 that protrudes from a front surface of the door 40 toward a front direction of the cooking apparatus 1. For example, the door handle 41 may be positioned adjacent to an upper end of the door 40.

The door 40 may form a door flow path 42 through which air flows inside the door 40. The door flow path 42 may extend from a lower end to an upper end of the door 40 inside the door 40. The door flow path 42 may be formed by penetrating the door 40 in a vertical direction. The door flow path 42 may cool the door 40. In other words, surface temperature of the door 40 may be relatively lowered by the door flow path 42. The door flow path 42 may reduce an amount of heat transferred from the inside of the cooking room 11 to outside of the door 40. The door flow path 42 may prevent a user touching a surface of the door 40 from being burned.

The cooking apparatus 1 may include the cooktop 20 provided above the main body 10. The cooktop 20 may be an induction heating device based on an induction heating method. The cooking apparatus 1 may include an oven, and an induction heating device provided above the oven.

The cooktop 20 may include a top plate 21. The top plate 21 may form an upper surface of the cooktop 20. The top plate 21 may support a cooking container. The top plate 21 may include tempered glass such as ceramic glass.

The top plate 21 may include a cooking zone. The cooktop 20 may inductively heat a cooking container placed on the cooking zone of the top plate 21. Although not shown in the drawings, the top plate 21 may be provided with a mark indicating the cooking zone to allow a user to recognize the cooking zone. For example, the top plate 21 may be provided with printing indicating the cooking zone. A plurality of cooking zones may be formed on the top plate 21.

For example, the top plate 21 may be formed with four cooking zones that are separated from each other.

Referring to FIGS. 2 and 3, the cooktop 20 may include the top plate 21, and a cooktop case 23 provided below the top plate 21 and forming a machine room 22.

The cooktop case 23 may have a box shape of which an upper side opens. The open upper side of the cooktop case 23 may be covered by the top plate 21. The cooktop case 23 and the top plate 21 may form the machine room 22 in which electronic components and a fan 60 are accommodated.

The cooktop 20 may include a coil 51 accommodated in the machine room 22. The coil 51 may be positioned below the top plate 21 to inductively heat a cooking container placed on the top plate 21. Current of which a magnitude changes over time may be applied to the coil 51. As current is applied to the coil 51, a magnetic field may be formed around the coil 51. As a magnitude of current applied to the coil 51 changes, a magnetic field formed around the coil 51 may change. According to a change in the magnetic field, eddy current may flow on a surface of a cooking container that is in contact with the top plate 21, and the cooking container may be heated by the eddy current. The coil 51 may be referred to as an induction heating coil.

The cooktop 20 may include a fixing member 52. The fixing member 52 may support the coil 51. The fixing member 52 may surround the coil 51. The fixing member 52 may be fixed to an inner side of the cooktop case 23. Because the fixing member 52 supporting the coil 51 is fixed to the inner side of the cooktop case 23, the coil 51 may be fixed to the inner side of the cooktop case 23.

The cooktop 20 may include a control board 53 positioned in the machine room 22 formed inside the cooktop case 23. Components for controlling the cooking apparatus 1 may be mounted on the control board 53. Components for controlling the main body 10 and the cooktop 20 may be mounted on the control board 53. A circuit for controlling the main body 10 and the cooktop 20 may be implemented on the control board 53. The control board 53 may supply driving current to the coil 51. The control board 53 may implement a circuit for operating the coil 51. The control board 53 may include various components and/or circuits for supplying driving current to the coil 51.

The cooktop 20 may include the fan 60 positioned inside the machine room 22. The fan 60 may cool inside of the machine room 22 by forming a flow of air inside the machine room 22.

According to an embodiment, the cooktop 20 may include a first fan 61 and a second fan 62 positioned in a rear space of the machine room 22. The first fan 61 may be positioned adjacent to one side of the machine room 22, and the second fan 62 may be positioned adjacent to another side of the machine room 22.

Each of the first fan 61 and the second fan 62 may form a flow of air toward the front direction. In other words, the first fan 61 may discharge air entered the first fan 61 in a front direction of the first fan 61. The second fan 62 may discharge air entered the second fan 62 in a front direction of the second fan 62.

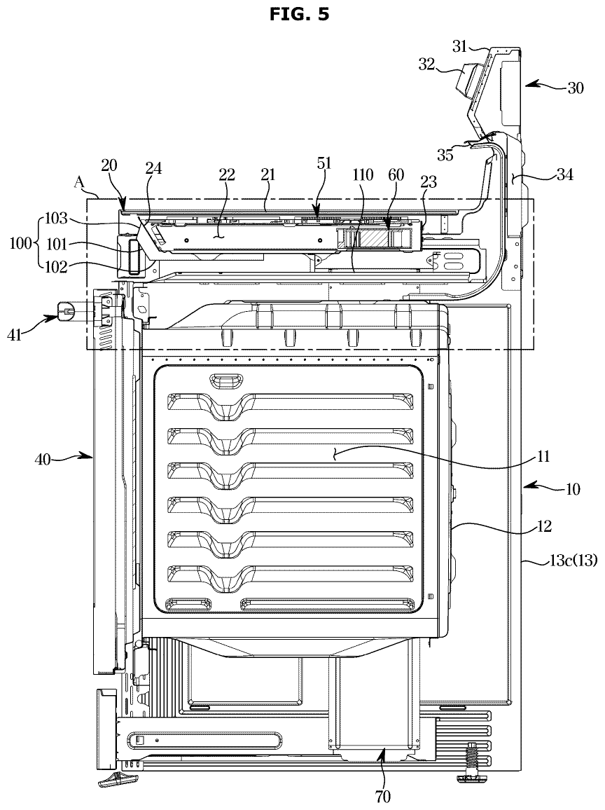

According to an embodiment, the cooking apparatus 1 may include a protruding portion 30 that protrudes upward from a rear end of the cooktop 20. Inside the protruding portion 30, a discharge flow path 34 (see FIG. 5) through which air flows may be formed. On at least a part of a front surface of the protruding portion 30, a control panel 31 may be provided. Below the control panel 31, an outlet 35 (see FIG. 5) through which air moved along the discharge flow path 34 is discharged may be formed.

The control panel 31 may be positioned on at least one part of the front surface of the protruding portion 30 toward the front direction of the cooking apparatus 1. The control panel 31 may include a plurality of knobs 32. A user may use the plurality of knobs 32 to operate or control the cooking apparatus 1. For example, the user may control temperature of the cooking room 11 inside the main body 10, turn the cooktop 20 on/off, or control temperature of the cooking zone.

The control panel 31 may further include a display 33 for displaying various information for the cooking apparatus 1. For example, the display 33 may be positioned at a center of the control panel 31. For example, the display 33 may display internal temperature of the cooking room 11. For example, the display 33 may display an output magnitude of each of a plurality of cooking zones.

FIG. 4 is a bottom perspective view of a cooktop and a protruding portion in a cooking apparatus according to an embodiment.

A duct 70 of the cooking apparatus 1 according to an embodiment will be described with reference to FIGS. 3 and 4.

The cooking apparatus 1 may include the duct 70 that extends toward the fan 60 from a lower portion of the main body 10 to guide air below the main body 10 to the fan 60. The duct 70 may be positioned to inner sides of the side panels 13b of the main body 10 to be prevented from being exposed to outside of the main body 10. The duct 70 may be positioned adjacent to the side panels 13b of the main body 10.

The duct 70 may include a first duct 71 and a second duct 72. The first duct 71 may be positioned to one side of the main body 10 to guide air to the first fan 61. The first duct 71 may be positioned to an inner side of one side panel 13b forming one side of the main body 10. The second duct 72 may be positioned to another side of the main body 10 to guide air to the second fan 62. The second duct 72 may be positioned to an inner side of another side panel 13b forming another side of the main body 10.

The first duct 71 may include a first duct portion 71b extending substantially vertically on one side of the main body 10 and having an air inlet 71a formed at a lower end. The first duct 71 may include a second duct portion 71c extending substantially horizontally from an upper end of the first duct portion 71b toward the first fan 61 and having an air outlet. The first duct 71 may include a third duct portion 71d coupled to a bottom of the cooktop case 23 and connected to the second duct portion 71c.

The cooktop case 23 may include a first fan hole formed below the first fan 61. The first fan hole may be formed by penetrating the bottom of the cooktop case 23. Air moved along the first duct 71 may flow into the first fan 61 through the first fan hole. The third duct portion 71d may cover the first fan hole below the cooktop case 23. The third duct portion 71d may be connected to the second duct portion 71c and may guide air discharged through the air outlet of the second duct portion 71c to the first fan 61. The third duct portion 71d may form a preset space below the cooktop case 23.

The second duct 72 may include a first duct portion 72b extending substantially vertically on another side of the main body 10 and having an air inlet 72a formed at a lower end. The second duct 72 may include a second duct portion 72c extending substantially horizontally from an upper end of the first duct portion 72b toward the second fan 62 and having an air outlet. The second duct 72 may include a third duct portion 72d coupled to the bottom of the cooktop case 23 and connected to the second duct portion 72c.

The cooktop case 23 may include a second fan hole formed below the second fan 61. The second fan hole may be formed by penetrating the bottom of the cooktop case 23. Air moved along the second duct 72 may flow into the second fan 62 through the second fan hole. The third duct portion 72d may cover the second fan hole below the cooktop case 23. The third duct portion 72d may be connected to the second duct portion 72c and may guide air discharged through the air outlet of the second duct portion 72c to the second fan 62. The third duct portion 72d may form a preset space below the cooktop case 23.

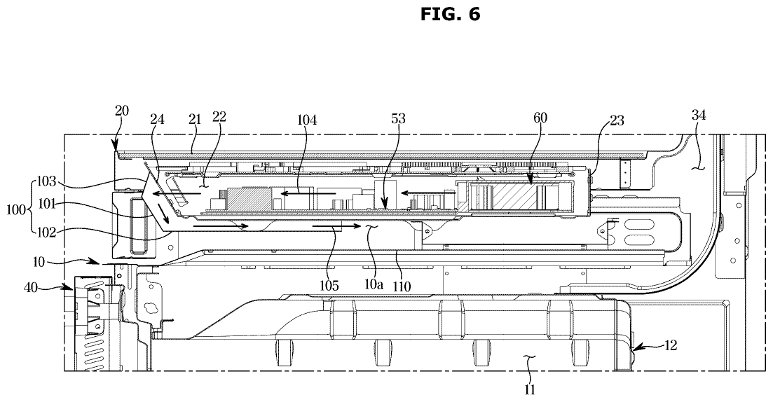

FIG. 5 is a side cross-sectional view of a cooking apparatus according to an embodiment. FIG. 6 is an enlarged view of an area A of FIG. 5.

A flow of air of the air conditioner 1 according to an embodiment will be described with reference to FIGS. 5 and 6.

Referring to FIGS. 5 and 6, the cooking apparatus 1 may include an air guide 100 that guides air discharged in a front direction of the machine room 22 by the fan 60 downward from the machine room 22. The air guide 100 may guide air discharged in the front direction of the machine room 22 downward from the cooktop case 23.

The cooktop case 23 may include an outlet 24 formed in a front side of the cooktop case 23 to discharge internal air of the machine room 22 to outside of the machine room 22. The outlet 24 may be formed by penetrating the front side of the cooktop case 23. The outlet 24 may include a plurality of holes and/or a hole extending in one direction.

The air guide 100 may guide air discharged in the front direction of the cooktop case 23 through the outlet 24 downward from the cooktop case 23. The air guide 100 may guide air discharged in the front direction of the machine room 22 downward from the machine room 22 and then guide the air toward a rear direction of the machine room 22. In other words, the air guide 100 may change a moving direction of air moving in a first direction by the fan 60 to a second direction that is opposite to the first direction. According to an embodiment, the first direction may be the front direction, and the second direction may be the rear direction.

The cooking apparatus 1 according to an embodiment may include the air guide 100 coupled to the front side of the cooktop case 23, thereby causing air that has cooled inside of the cooktop 20 to pass between the cooktop 20 and the main body 10 without being directly discharged to the outside of the cooktop 20. In other words, air moving in the front direction 104 by the fan 60 may be discharged to the outside of the machine room 22 through the outlet 24 formed in the front side of the cooktop case 23, and the air discharged to the outside of the machine room 22 may move downward by the air guide 100. At this time, a moving direction of the air may be reversed. The air moved downward by the air guide 100 may move toward the rear direction below the cooktop case 23.

Air moving in the rear direction 105 below the cooktop case 23 may be discharged to the outside of the cooking apparatus 1 together with stagnant heat in a space 10a between the cooktop 20 and the main body 10. The space 10a between the main body 10 and the cooktop 20 may be below the machine room 22, below the cooktop case 23, or above the main body 10.

Because stagnant heat in the space 10a between the cooktop 20 and the main body 10 is discharged to the outside of the cooking apparatus 1, the space 10a between the main body 10 and the cooktop 20 may be cooled. While internal temperature of the cooking room 11 rises, heat may be transferred upward from the main body 10. Therefore, heat may be transferred to the space 10a between the main body 10 and the cooktop 20, and the heat may be transferred to the machine room 22 to damage electronic components inside the machine room 22. As described above, air guided to the space 10a between the main body 10 and the cooktop 20 by the air guide 100 may move to a rear portion of the cooking apparatus 1 together with stagnant heat in the space 10a and then, be discharged to the outside of the cooking apparatus 1 along the discharge flow path 34 formed inside the protruding portion 30. Due to the air guide 100, stagnant heat in the space 10a between the main body 10 and the cooktop 20 may be discharged to the outside of the cooking apparatus 1, which prevents the space 10a between the main body 10 and the cooktop 20 from being overheated while preventing the electronic components inside the machine room 22 from being damaged by heat.

Referring to FIG. 6, the air guide 100 may include a cover guide 101 that covers an area spaced in the front direction from the front side of the cooktop case 23 to guide air discharged in the front direction of the machine room 22 through the outlet 24 of the cooktop case 23 downward from the machine room 22. The cover guide 101 may be inclined downward toward the rear direction to guide air moving in the front direction downward.

The air guide 100 may include an extension guide 102 that is spaced downward from the bottom of the cooktop case 23 and connected to the cover guide 101 to guide air moved downward from the machine room 22 by the cover guide 101 in the rear direction. The extension guide 102 may extend horizontally along a front-rear direction.

As shown in FIG. 6, the extension guide 102 may extend to substantially a center of the bottom of the cooktop case 23. Alternatively, the extension guide 102 may extend to a rear end of the bottom of the cooktop case 23 or adjacent to the rear end of the bottom of the cooktop case 23.

The air guide 100 may further include an upper cover 103 that prevents air discharged in the front direction of the machine room 22 from moving upward along the cover guide 101 and being discharged upward from the machine room 22. The upper cover 103 may be connected to the cover guide 101 and the front side of the cooktop case 23. The upper cover 103 may extend substantially vertically, although not limited thereto. However, the upper cover 103 may be inclined to connect an upper end of the cover guide 101 to a portion of the front side of the cooktop case 23.

Referring to FIGS. 5 and 6, the cooking apparatus 1 may include a cover plate 110 positioned below the cooktop case 23. The cover plate 110 may form an upper side of the outer case 13, although not limited thereto. An upper panel forming the upper side of the outer case 13 may be provided separately and the cover plate 110 may be positioned on the upper panel.

The cover plate 110 may prevent the insulation surrounding the inner case 11 from being exposed below the cooktop case 23. The cover plate 110 may cover the insulation positioned on an upper side of the inner case 11 forming the cooking room 11. Because the cover plate 110 covers an upper side of the insulation, an amount of heat transferred upward from the insulation may be reduced. The cover plate 110 may be positioned below the cooktop case 23 or above the main body 10 to reduce an amount of heat transferred to the space 10a between the cooktop 20 and the main body 10.

Also, unlike the drawings, the outer case 11 may include an upper panel accommodating the insulation therein, and the cover plate 110 may be provided on the upper panel of the outer case 11. In this case, the cover plate 110 may be spaced a preset distance upward from an upper side of the upper panel. Through this arrangement, an air gap may be formed between the upper panel and the cover plate 110, and the air gap may reduce transfer of heat.

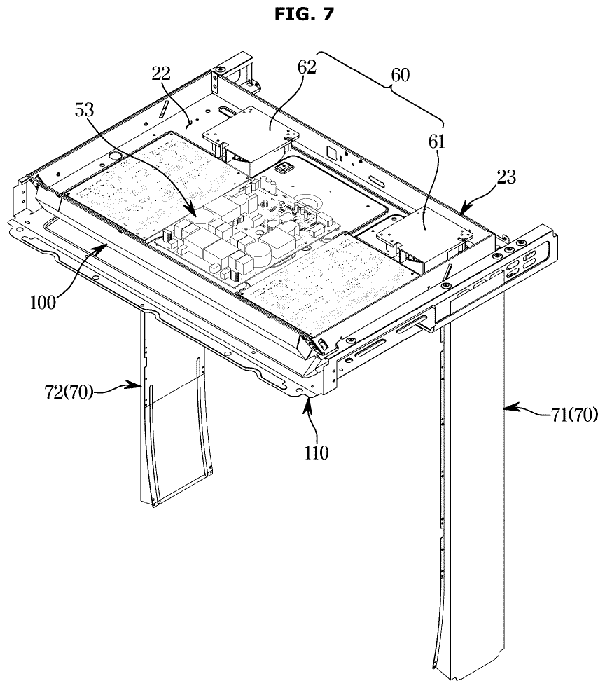

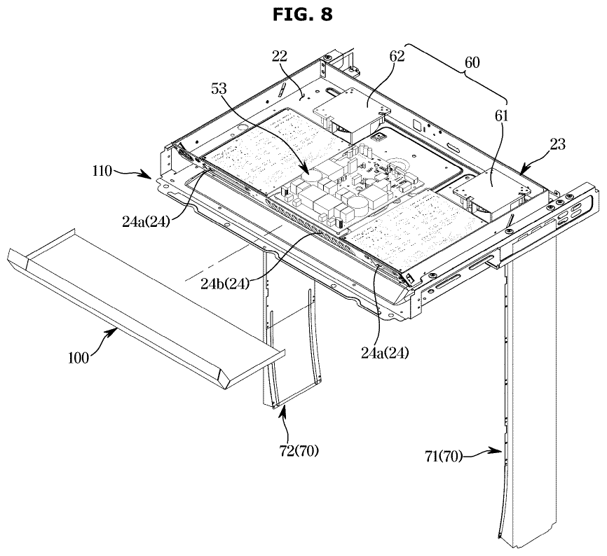

FIG. 7 shows some components of a cooking apparatus according to an embodiment. FIG. 8 shows some components of the cooking apparatus shown in FIG. 7 and an air guide separated from the components.

Referring to FIGS. 7 and 8, in the cooking apparatus 1 according to an embodiment, the air guide 100 may be coupled to the front side of the cooktop case 23. As described above, because the first fan 61 and the second fan 62 are arranged in the rear space of the machine room 22 to form a flow of air toward the front direction, the air guide 100 may be coupled to the front side of the cooktop case 23 and positioned in front of the machine room 22.

The cooktop case 23 may include the outlet 24 formed in the front side of the cooktop case 23. The outlet 24 may include, but is not limited to, a pair of first outlets 24a which are holes respectively formed in the front direction of the first fan 61 and the second fan 62 and having relatively great sizes, and a plurality of second outlets 24b which are a plurality of holes formed between the pair of first outlets 24a and having relatively small sizes. However, the outlet 24 may include only a plurality of holes or a single hole extending in a left-right direction. Also, the outlet 24 may include a plurality of holes having a different shape from that shown in FIGS. 7 and 8.

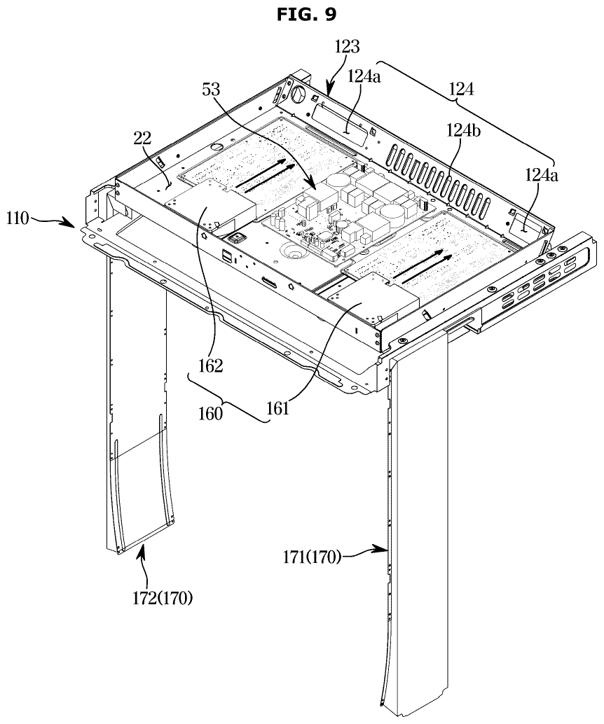

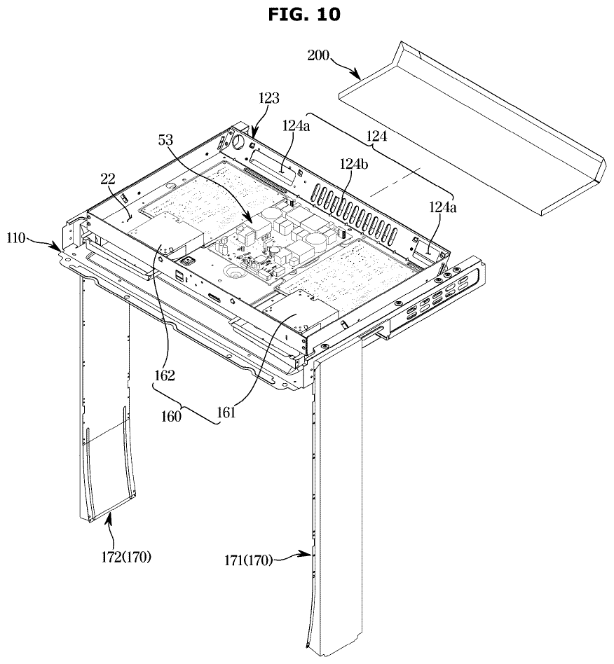

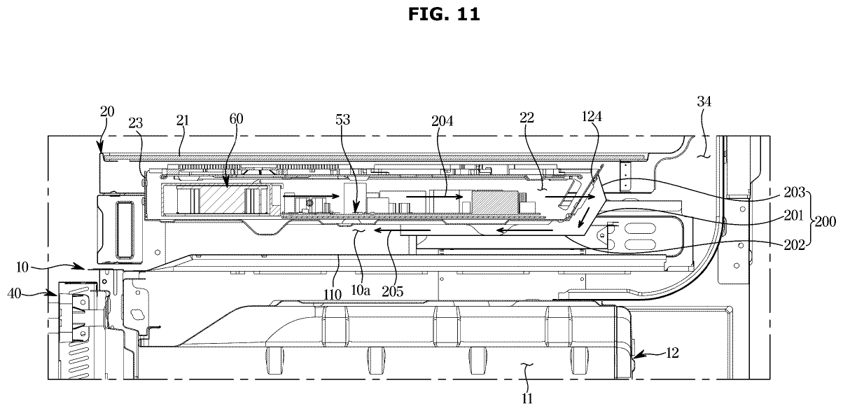

FIG. 9 shows some components of a cooking apparatus according to an embodiment. FIG. 10 shows some components of the cooking apparatus shown in FIG. 9 and an air guide separated from the components. FIG. 11 is an enlarged view showing a part of a side cross section of a cooking apparatus according to an embodiment.

Referring to FIGS. 9 and 10, the cooking apparatus 1 may include a cooktop case 123 forming the machine room 22, and an outlet 124 formed in a rear side of the cooktop case 123. Also, the cooking apparatus 1 may include a fan 160 positioned in a front space of the machine room 22, and a duct 170 that guides air to the fan 160. The fan 160 may be positioned in the front space of the machine room 22 to form a flow of air toward the rear direction. The fan 160 may include a first fan 161 positioned to one side of the machine room 22 and a second fan 162 positioned to another side of the machine room 22. The duct 170 may include a first duct 171 positioned to one side of the main body 10 to guide air below the main body 10 to the first fan 161, and a second duct 172 positioned to another side of the main body 10 to guide air below the main body 10 to the second fan 162.

According to an embodiment, the cooking apparatus 1 may include an air guide 200 that guides air discharged in the rear direction of the machine room 22 by the fan 160 downward from the machine room 22. The air guide 200 may guide air discharged in the rear direction of the machine room 22 downward from the cooktop case 123.

The cooktop case 123 may include the outlet 124 formed in the rear side of the cooktop case 123 to discharge internal air of the machine room 22 to the outside of the machine room 22. The outlet 124 may be formed by penetrating the rear side of the cooktop case 123. The outlet 124 may include a plurality of holes and/or a hole extending in one direction.

The air guide 200 may guide air discharged in the rear direction of the cooktop case 123 through the outlet 124 downward from the cooktop case 123. The air guide 200 may guide air discharged in the rear direction of the machine room 22 downward from the machine room 22 and then guide the air toward the front direction of the machine room 22. In other words, the air guide 200 may change a moving direction of air moving in a first direction by the fan 160 to a second direction that is opposite to the first direction. According to an embodiment, the first direction may be the rear direction, and the second direction may be the front direction.

The cooking apparatus 1 according to the disclosure may include the air guide 200 coupled to the rear side of the cooktop case 123, thereby causing air that has cooled the inside of the cooktop 20 to pass between the cooktop 20 and the main body 10 without being directly discharged to the outside of the cooktop 20. In other words, air 204 moving in the rear direction by the fan 160 may be discharged to the outside of the machine room 22 through the outlet 124 formed in the rear side of the cooktop case 123, and the air discharged to the outside of the machine room 22 may move downward by the air guide 200. At this time, a moving direction of the air may be reversed. The air moved downward by the air guide 100 may move toward the front direction below the cooktop case 123.

Air 205 moved in the front direction below the cooktop case 123 may be discharged to the outside of the cooking apparatus 1 together with stagnant heat in the space 10a between the cooktop 20 and the main body 10. The space 10a between the main body 10 and the cooktop 20 may be below the machine room 22, below the cooktop case 123, or above the main body 10.

Because stagnant heat in the space 10a between the main body 10 and the cooktop 20 is discharged to the outside of the cooking apparatus 1, the space 10a between the main body 10 and the cooktop 20 may be cooled. While internal temperature of the cooking room 11 rises, heat may be transferred upward from the main body 10. Therefore, heat may be transferred to the space 10a between the main body 10 and the cooktop 20, and the heat may be transferred to the machine room 22 to damage the electronic components inside the machine room 22. As described above, air guided to the space 10a between the main body 10 and the cooktop 20 by the air guide 200 may move to the front portion of the cooking apparatus 1 together with stagnant heat in the space 10a and then, be discharged to the outside of the cooking apparatus 1. Therefore, the space 10a between the main body 10 and the cooktop 20 may be prevented from being overheated, and also, the electronic components inside the machine room 22 may be prevented from being damaged by heat.

Referring to FIGS. 10 and 11, the air guide 200 may include a cover guide 201 that covers an area spaced downward from the rear side of the cooktop case 23 to guide air discharged in the rear direction of the machine room 22 through the outlet 124 of the cooktop case 123 downward from the machine room 22. The cover guide 201 may be inclined downward toward the front direction to guide air moving in the rear direction downward.

The air guide 200 may include an extension guide 202 that is spaced downward from the bottom of the cooktop case 123 and connected to the cover guide 201 to guide air moved downward from the machine room 22 by the cover guide 201 in the front direction. The extension guide 202 may extend horizontally along the front-rear direction.

As shown in FIG. 11, the extension guide 202 may extend to substantially a center of the bottom of the cooktop case 123. Alternatively, the extension guide 102 may extend to a front end of the bottom of the cooktop case 123 or adjacent to the front end of the bottom of the cooktop case 123.

The air guide 200 may further include an upper cover 203 that prevents air discharged in the front direction from the machine room 22 from moving upward along the cover guide 201 and being discharged upward from the machine room 22. The upper cover 203 may be connected to the cover guide 201 and the rear side of the cooktop case 123. The upper cover 203 may extend substantially vertically. However, the present disclosure is not limited thereto, and the upper cover 203 may be inclined to connect an upper end of the cover guide 201 to a portion of the front side of the cooktop case 123.

Referring to FIGS. 9 and 10, in the cooking apparatus 1 according to an embodiment, the air guide 200 may be coupled to the rear side of the cooktop case 123. As described above, because the first fan 161 and the second fan 162 are arranged in the front space of the machine room 22 to form a flow of air toward the rear direction, the air guide 200 may be coupled to the rear side of the cooktop case 123 and positioned behind the machine room 22.

The cooktop case 123 may include the outlet 124 formed in the rear side of the cooktop case 123. The outlet 124 may include, but is not limited to, a pair of first outlets 124a which are holes respectively formed in the rear direction of the first fan 161 and the second fan 162 and having relatively great sizes, and a plurality of second outlets 124b which are a plurality of holes formed between the pair of first outlets 124a and having relatively small sizes, although not limited thereto. However, the outlet 124 may include only a plurality of holes or a single hole extending in the left-right direction. Also, the outlet 124 may include a plurality of holes having a different shape from that shown in FIGS. 9 and 10.

A cooking apparatus according to an embodiment may include a main body forming a cooking room, a cooktop including a machine room accommodating an induction heating coil and a fan positioned inside the machine room, the cooktop positioned above the main body, a duct extending from a lower portion of the main body toward the fan and configured to guide air below the main body to the fan, and an air guide configured to guide air discharged to one side of the machine room by the fan downward from the machine room. The air guide may be configured to guide air guided from the one side of the machine room downward from the machine room toward another side of the machine room.

The air guide may be configured to change a moving direction of air moving in a first direction by the fan to a second direction that is opposite to the first direction.

Air moving below the machine room along the air guide may discharge stagnant heat between the main body and the machine room to outside.

The fan may be positioned in a rear space of the machine room and form a flow of air toward a front direction, and the air guide may be positioned to a front side of the machine room.

The air guide may include a cover guide covering an area spaced in the front direction from the front side of the machine room and configured to guide air discharged in the front direction of the machine room downward from the machine room.

The air guide may include an extension guide spaced downward from a bottom of the machine room, connected to the cover guide, and configured to guide air moved downward from the machine room by the cover guide in a rear direction.

The cover guide may be inclined downward toward the rear direction to guide air moving in the front direction downward.

The fan may be positioned in a front space of the machine room and configured to form a flow of air toward a rear direction. The air guide may be positioned to a rear side of the machine room.

The air guide may include a cover guide covering an area spaced in the rear direction from the rear side of the machine room and configured to guide air discharged in the rear direction of the machine room downward from the machine room.

The air guide may include an extension guide spaced downward from the bottom of the machine room, connected to the cover guide, and configured to guide air moved downward from the machine room by the cover guide in the front direction.

The cover guide may be inclined downward toward the front direction to guide air moving in the rear direction downward.

The duct may include a first duct portion extending vertically on one side of the main body and including an air inlet formed at a lower end, and a second duct portion extending horizontally toward the fan from an upper end of the first duct portion and including an air outlet formed at one end.

The machine room may include a fan hole formed below the fan.

The duct may further include a third duct portion coupled to a bottom of the machine room to be positioned below the fan hole, and connected to the second duct portion.

The fan may include a first fan positioned to one side of the machine room, and a second fan positioned to another side of the machine room.

The duct may include a first duct positioned on one side of the main body and configured to guide air to the first fan, and a second duct positioned on another side of the main body and configured to guide air to the second fan.

The main body may include an inner case forming the cooking room, wherein a front side of the inner case opens, an outer case accommodating the inner case therein and positioned below the cooktop, and an insulation positioned between the inner case and the outer case and configured to insulate between the inner case and the outer case.

The outer case may include a cover plate forming an upper side of the outer case.

The cover plate may cover the insulation to prevent the insulation from being exposed below the machine room.

The cooking apparatus may further include a protruding portion protruding upward from a rear end of the cooktop and forming a flow path therein.

A control panel on which a plurality of knobs are arranged may be positioned on at least a part of a front surface of the protruding portion.

According to a concept of the disclosure, a cooking apparatus for discharging stagnant heat between an oven and an induction cooktop to the outside of the cooking apparatus by using fans provided inside the induction cooktop is provided.

According to a concept of the disclosure, a cooking apparatus including an oven and an induction cooktop provided above the oven and capable of discharging stagnant heat above the oven to the outside without adding a separate fan is provided.

According to a concept of the disclosure, a cooking apparatus for discharging heat above an oven to the outside by guiding air that has cooled the inside of an induction cooktop over the oven is provided.

So far, specific embodiments have been shown and described. However, the disclosure is not limited to the above-described embodiments, and various modifications can be made by one of ordinary skill in the technical art to which the disclosure belongs without departing from the gist of the technical idea of the disclosure defined by the claims below.

1. A cooking apparatus comprising:
a main body forming a cooking room;
a cooktop including a machine room to accommodate an induction heating coil and a fan, the cooktop being positioned above the main body;
a duct extending from a lower portion of the main body toward the fan and configured to guide air from below the main body to the fan; and
an air guide configured to:
guide air to a first side of the machine room by the fan, the air being guided along a downward direction from the machine room, and
wherein the air guide is configured to guide air guided from the first side of the machine room toward a second side of the machine room.

2. The cooking apparatus of claim 1, wherein
the air guide is configured to change a moving direction of air moving in a first direction by the fan to a second direction opposite to the first direction.

3. The cooking apparatus of claim 1, wherein
the air moving from below the machine room along the air guide discharges stagnant heat between the main body and the machine room to an outside of the cooking apparatus.

4. The cooking apparatus of claim 1, wherein
the fan is positioned in a rear space of the machine room and moves air toward a front direction, and
the air guide is positioned toward a front side of the machine room.

5. The cooking apparatus of claim 4, wherein
the air guide includes:
a cover guide covering an area spaced in the front direction from the front side of the machine room and configured to guide air discharged in the front direction of the machine room downward from the machine room, and
an extension guide spaced downward from a bottom of the machine room, connected to the cover guide, and configured to guide air moved downward from the machine room by the cover guide in a rear direction.

6. The cooking apparatus of claim 5, wherein
the cover guide is inclined downward toward the rear direction to guide air moving in the front direction downward.

7. The cooking apparatus of claim 1, wherein
the fan is positioned in a front space of the machine room and configured to form a flow of air toward a rear direction, and
the air guide is positioned on a rear side of the machine room.

8. The cooking apparatus of claim 7, wherein
the air guide includes:
a cover guide covering an area spaced in the rear direction from the rear side of the machine room and configured to guide air discharged in the rear direction of the machine room downward from the machine room, and
an extension guide spaced downward from a bottom of the machine room, connected to the cover guide, and configured to guide air moved downward from the machine room by the cover guide in a front direction.

9. The cooking apparatus of claim 8, wherein
the cover guide is inclined downward toward the front direction to guide air moving in the rear direction downward.

10. The cooking apparatus of claim 1, wherein
the duct includes:
a first duct portion extending vertically on one side of the main body and including an air inlet formed at a lower end, and
a second duct portion extending horizontally toward the fan from an upper end of the first duct portion and including an air outlet formed at one end.

11. The cooking apparatus of claim 10, wherein
the machine room includes a fan hole formed below the fan, and
the duct further includes a third duct portion coupled to a bottom of the machine room to be positioned below the fan hole, and connected to the second duct portion.

12. The cooking apparatus of claim 1, wherein
the fan includes a first fan positioned to the first side of the machine room, and a second fan positioned to the second side of the machine room, and
the duct includes a first duct positioned on a first side of the main body and configured to guide air to the first fan, and a second duct positioned on a second side of the main body and configured to guide air to the second fan.

13. The cooking apparatus of claim 1, wherein
the main body includes:
an inner case forming the cooking room, wherein a front side of the inner case opens,
an outer case accommodating the inner case therein and positioned below the cooktop, and
an insulation positioned between the inner case and the outer case and configured to insulate between the inner case and the outer case.

14. The cooking apparatus of claim 13, wherein
the outer case includes a cover plate forming an upper side of the outer case, and
the cover plate covers the insulation to prevent the insulation from being exposed below the machine room.

15. The cooking apparatus of claim 1, further comprising
a protruding portion protruding upward from a rear end of the cooktop and forming a flow path therein,
wherein a control panel on which a plurality of knobs are arranged is positioned on at least a part of a front surface of the protruding portion.
